(19) United States
(12) Patent Application Publication
(10) Pub. No.: US 2017/0041764 A1
(43) Pub. Date: Feb. 9, 2017

(54) METHOD AND SYSTEM FOR LIMITING THE FUNCTIONALITY OF A MOBILE COMMUNICATIONS DEVICE ASSOCIATED WITH A VEHICLE

(71) Applicants: David Nizgoda, Las Vegas, NV (US); Ofir Ventura, Las Vegas, NV (US)

(72) Inventors: David Nizgoda, Las Vegas, NV (US); Ofir Ventura, Las Vegas, NV (US)

(21) Appl. No.: 15/008,685

(22) Filed: Jan. 28, 2016

Related U.S. Application Data
(60) Provisional application No. 62/200,308, filed on Aug. 3, 2015.

(51) Int. Cl. H04W 4/04; H04W 48/04

(52) U.S. Cl. CPC H04W 4/046; H04W 48/04

(57) ABSTRACT

A system and method are provided for limiting the functionality of a mobile communications device when it is associated with a vehicle. Texting, email, browser and other functionality of a mobile communications device is limited when the mobile communications device is communicatively coupled, such as by Bluetooth, to the vehicle and a qualifying vehicle condition, such as detection of a driver in the driver's seat and/or detection of the vehicle in a drive, reverse or neutral condition, is detected.

### RELATED APPLICATION DATA

This application claims priority to U.S. Provisional Application Ser. No. 62/200,308, filed Aug. 3, 2015.

### FIELD OF THE INVENTION

The present invention relates to mobile communication devices and vehicle control and communication or entertainment systems.

### BACKGROUND OF THE INVENTION

The use of a mobile communications device, such as a cell phone or PDA, when driving a vehicle is a prevalent problem which present a significant safety hazard. Unfortunately, even legislation prohibiting the use of such devices has not proven effective in preventing drivers from using these devices.

Some technology has been proposed to aid in solving this problem. However, the proposed solutions generally suffer from various drawbacks. For example, some solutions prevent the driver from using their device when the vehicle is not moving. Other solutions also prevent the passenger from using their device. Yet other solutions can easily be thwarted (such as turned on or turned off), thus limiting their effectiveness.

An improved method and system for controlling the use of a mobile communications device associated with a vehicle is desired.

### SUMMARY OF THE INVENTION

Aspects of the invention comprise a system and method for limiting the functionality of a mobile communications device when it is associated with a vehicle.

In one embodiment, functionality of a mobile communications device is limited when the mobile communications device is communicatively coupled, such as by Bluetooth or other wireless communication links, to a vehicle, such as a vehicle's entertainment or communications system. In one embodiment, the functionality is limited upon detection of a qualifying vehicle condition, such as detection of a driver in the driver's seat and/or detection of the vehicle in a drive, reverse or neutral condition.

The system and method of the invention may limit use of or disable various mobile communication device functionality, such as texting, email or web browsing functionality, by disabling applications supporting such functionality or by blocking use of user input devices such as a keypad or touchscreen of the mobile communications device. In one embodiment, when functionality of the mobile communications device is limited, only voice communications are permitted via the mobile communications device (directly, or effected via or through the use of the vehicle's communications or entertainment system).

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system in accordance with the present invention;

FIG. 2 is a block diagram of a system in accordance with yet another embodiment of the invention; and

FIG. 3 is a flow diagram of a method in accordance with one embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

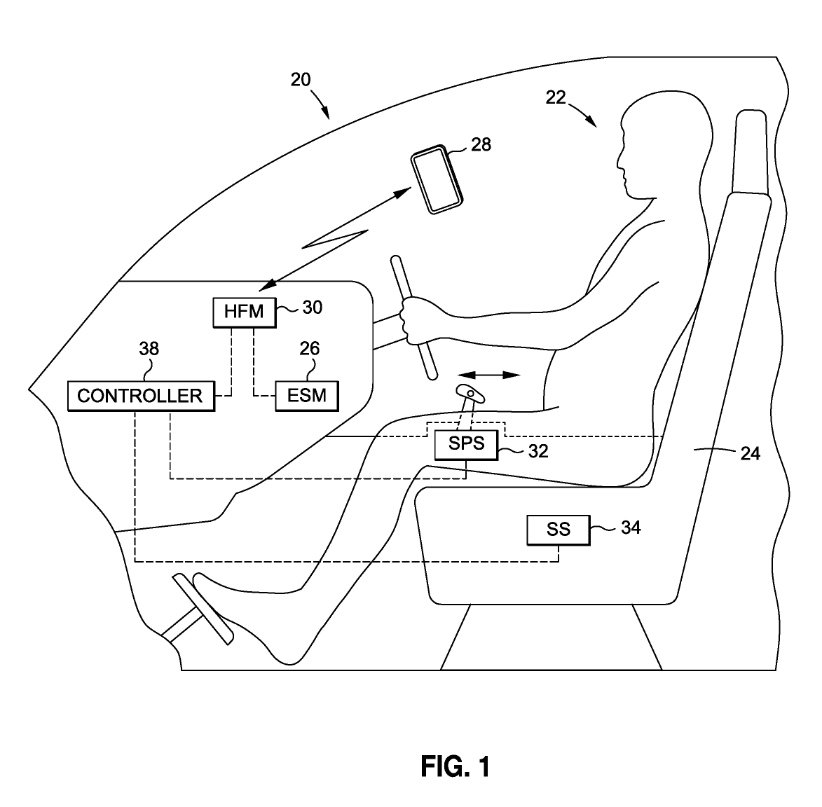

Embodiments of the invention comprise methods and systems for limiting the functionality or operation of a mobile communications device when it is associated with a vehicle. One embodiment of a system of the invention will be described with reference to FIG. 1. As illustrated therein, a vehicle 20 is configured to be driven by a driver 22 when the driver is positioned in a driver's seat 24. It will be appreciated that the configuration of the vehicle 20 may vary and comprise a car, van, pickup, SUV, motorcycle, trike, semi-truck or other configurations of vehicles now known or later developed. Such vehicles may be powered in various manners, such as by one or more fuel burning engines, one or more electric motors or other power sources or combinations thereof.

In general, the vehicle 20 preferably includes one or more control systems. The control system may comprise or include an audio or entertainment system 26 which permits a mobile communication device 28 to be “paired” or communicatively coupled thereto, thus permitting the driver to use the entertainment system 26 as an interface to the mobile communication device 28. The entertainment system 26 may include a controller, a video display, one or more microphones, one or more amplifiers, one or more speakers, and one or more user input device, such as a touchscreen associated with the video display, a keypad, or other devices. Such entertainment systems 26 are well known and may vary, such as depending upon the particular vehicle manufacturer, model of the vehicle or the like.

In one embodiment, the mobile communication device 28 may be communicatively linked to the entertainment system 26, such as via a hands-free module 30. This module 30 may, for example, support Bluetooth or other wireless communications between the entertainment system 26 and the mobile communication device 28. Of course, one or more wired communication links might also be provided, such as via a cable between the mobile communications device 28 an a communication port in the vehicle. When communicatively linked, the vehicle's communication or entertainment system serves as an extension of the mobile communications device, permitting the user to control or use the mobile communications device via the vehicle.

In one embodiment, functionality of the mobile communications device 28 is dependent upon a detected condition of the vehicle 20 and/or driver 22, such as via a shift position sensor 32, seat sensor 34, restraint device/seat belt sensor or other sensor(s). In particular, as illustrated, a shift position sensor 32 or other sensor may be used to determine a driving condition of the vehicle (e.g. distinguish between whether the car is in park or is in drive (a forward or rear drive gear or neutral)). Likewise, a seat sensor 34 may be associated with the driver's seat 24 to determine when a driver is located in the driver's seat 24 of the vehicle 20. The seat sensor 34 may be, for example, a pressure-type sensor. The driver's seat occupancy sensor might instead, or additionally comprise, a restraint device or seat belt sensor (such as detecting that the driver's seat belt is latched).

In one embodiment, the vehicle sensors such as the shift position sensor 32 and the seat sensor 34 may communicate with one or more controllers 38 of the vehicle 20. The vehicle controller 38 may also communicate with the entertainment system 26 and/or hands-free module 30.

In general, in one embodiment of a method of the invention, functionality of the mobile communications device 28 is prevent or limited, preferably based upon a detected condition of the vehicle 20. The mobile communications device 28 may have a variety of configurations and comprise, for example, a phone, a smart phone, a pad, a tablet, a laptop or other device which is preferably portable. Most preferably, the mobile communications device 28 permits voice communications between the user and one or more remote locations. The mobile communications device 28 may also permit the transmission of text messages, email, and/or other information/data, such as by including text, email, web browser or other applications or functionality.

In a preferred embodiment of the invention, when the mobile communications device 28 is communicatively coupled to the vehicle, such as the entertainment system 26 of the vehicle 20, and one or more triggering, designated or qualifying vehicle conditions are detected, operation of the mobile communications device 28 is limited. Preferably, communications via the mobile communications device 28 are limited to voice communications only (either directly, or via or through the entertainment system 26). In one embodiment, the detected vehicle condition comprises a driver sitting in the driver's seat 24 (such as detected via the seat sensor 34 or a seat belt sensor or the like) or the vehicle being in a driving condition (such as the gear shift being in a “drive”, “reverse” or “neutral” position as detected by the shift position sensor 32). As detailed below, in various embodiments of the invention, limiting the functionality or operation of the mobile communications device 28 for voice communications only may be implemented by machine-executable code or “software”, such as implemented at the mobile communications device 28 and/or a controller associated with the vehicle 20.

At such time as communications are limited, the driver may utilize the mobile communications device 28 to place and respond to voice calls only, preferably through the vehicle's entertainment system 26. Preferably, the driver may not utilize the mobile communications device 28 for other purposes, including to receive or send text messages, receive or send email, browse the Internet or the like. In particular, such functionality is preferably blocked or disabled, such as via software. In one embodiment, communications via text, email, browser or the like may be limited to by blocking those communications at a communications interface or transceiver of the mobile communications device 28 and/or the vehicle 20. In other embodiments, a text application, an email application, a browser application, instant messaging or other application which facilitates communications via the mobile communications device 28 may be rendered inoperable (such as preventing the user from opening or using those applications). In other embodiments, it is possible to limit outgoing communications from the mobile communications device 28 only. In one embodiment, communications may be limited via the mobile communications device 28. In other embodiments, or additionally, communications may be limited by the vehicle 20 (for example, in a situation where communications with the mobile communications device 28 occurs through or via the vehicle, it is possible for the vehicle to intercept and thus limit the communications to and from the mobile communications device).

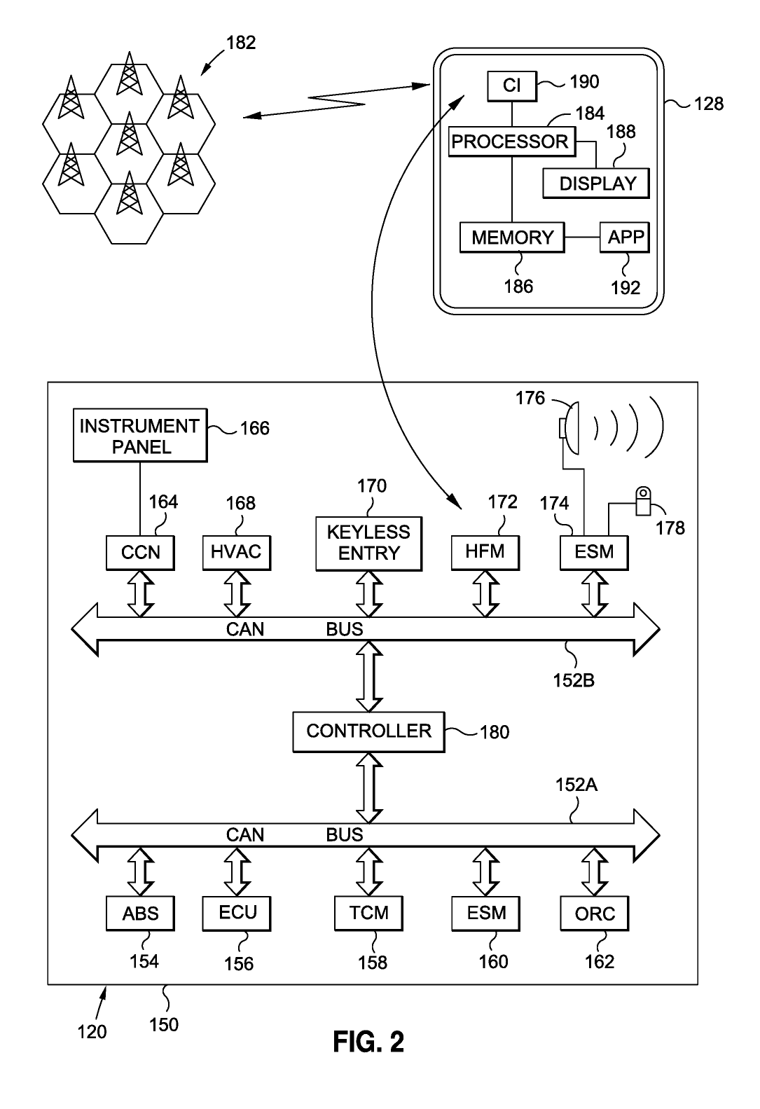

Additional details of the invention will be described with reference to FIG. 2. FIG. 2 illustrates in greater detail an example of a system of the present invention. As illustrated, a vehicle 120 has a control system 150. In this example embodiment, the control system 150 comprises one or more CAN BUS s 152 which serve as communication interfaces among components or systems of the control system 150. A first CAN BUS 152A may enable communications with and/or between various vehicle drive system related components, such as but not limited to: an ABS (anti-lock brake system) module 154, an ECU (engine control unit) 156, a TPS (tire pressure monitoring module) 158, an ESM (electronic shifter module) 160, and an ORC (occupant restraint control module) 162, among other components. These modules or components and their configuration, may vary, such as by including one or more controllers, sub-controllers, sensors and the like.

A second CAN BUS 152B may enabled communication with and/or between various secondary systems or components, such as but not limited to: a CCN (cabin compartment node) 164 (and associated instrument panel 166), an HVAC (heating/ventilation/air conditioning) system controller 168, a keyless entry module 170, an HFM (hands-free communication module) 172, an ESM (entertainment system/module) 174 (which as indicated above, may include a number of components such as one or more speakers 176, a microphone 178 and other input or output devices such as a display, keypad or other components). The first and second CAN BUS 152A,B may be linked to and communicate with a main controller or module 180. The main controller or module 180 may comprise one or more processors which are configured to execute hard coded instructions and/or include one or more memories which store machine-readable code or software for execution by the one or processors.

It will be appreciated that the control system 150 illustrated in FIG. 2 is just one configuration of a control system for a vehicle and it illustrated as just one exemplary environment for and embodiment of the present invention.

As illustrated, mobile communications device 128 may communicate with the control system 150 of the vehicle 120, such as via the HFM 172 (such as, for example, by Bluetooth wireless communications). The mobile communications device 128 may, in turn, communicate with one or more external network or systems, such as a cellular communication network 182.

One embodiment of a mobile communications device 128 is illustrated in FIG. 2. In this embodiment, the mobile communications device 128 comprises at least one processor 184 configured to execute machine readable code, receive inputs and generate one or more outputs. In one embodiment, the processor 184 is linked to at least one data storage device or “memory” 186 for storing machine readable code and/or other data. The processor 184 may generate one or more output signals or send data to one or more peripheral devices such as at least one video display 188 (and/or other components or devices such as a speaker(s), not shown). The processor 184 may also receive input from various input components or devices, such as a keypad, one or more buttons, a microphone, a touch screen or the like (not shown). In one embodiment, the mobile communications device 128 includes at least one communications interface, such as to permit wired or wireless communications, such in various protocols or formats, such as Wi-Fi, Bluetooth, 3G, 4G, 5G, GSM, CDMA, or various other formats now known or later developed.

In one embodiment of the invention, the mobile communications device 128 is configured with a control feature, such as implemented by a software application 192 which is installed (during manufacture) or downloaded later. The software application 192 may comprise machine readable code or software which is stored in the memory 186 and which is executable by the processor 184. It is also contemplated that various of the functionality implemented by the software application 192 may be implemented as hardware (such as via a dedicated chip).

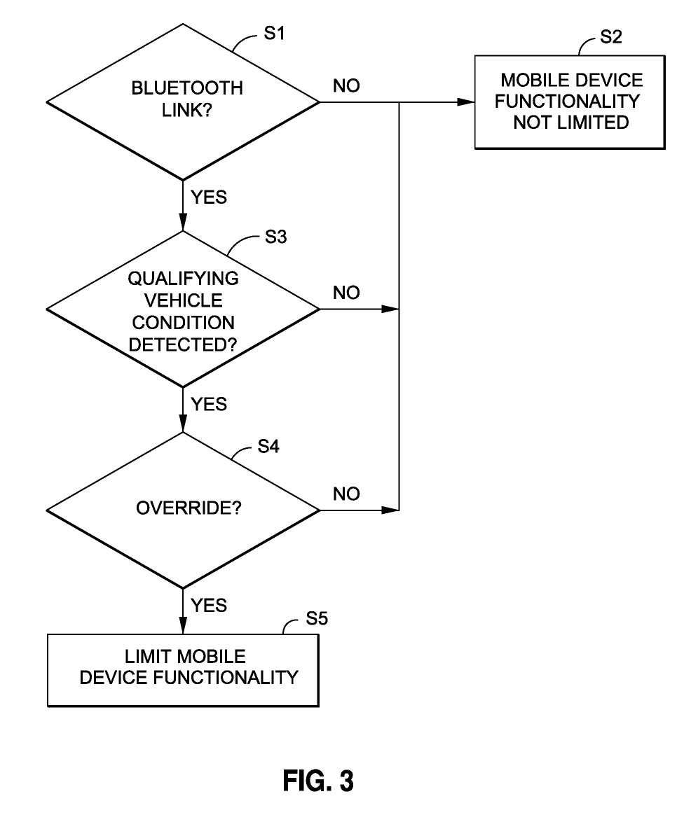

In one embodiment, the mobile communications device 28 and/or the vehicle 20 are configured to implement the functionality indicated in FIG. 3, such as via software executed by the mobile communications device 28 and/or the control system of the vehicle 20. As illustrated therein, in a first step S1, it is determined if there is a communication link formed between the mobile communications device and a vehicle communications or entertainment system, such as via a Bluetooth communications link. If not, then the functionality of the mobile communications device is not limited, as in step S2.

If such a communications link does exist, then in a step S3, it is determined if a qualifying vehicle condition is detected. Such may comprise, for example, determining if a driver is sitting in the driver's seat and/or determining if the vehicle is an operating or “driving” condition. For example, relative to the configuration illustrated in FIG. 2, the software application 192 may cause the processor 184 to send out an interrogation signal via the HFM 172 of the vehicle 120 to the occupant restraint control module 162 (and/or associated driver's seat sensor) for information regarding whether a driver is sitting in the driver's seat and/or to the TCM 158 and/or ESM 160 regarding whether the car is in park or a drive condition such as drive, neutral or reverse (or such information/data may automatically be transmitted to the mobile communications device 128). If it is determined that a driver is sitting in the driver's seat and/or that the vehicle is in a driving condition (such by being in a “drive”, “reverse” or “neutral” transmission condition), then a qualifying condition may be determined. If not, the functionality of the mobile communications device may not be limited.

If so, then in one embodiment, in a step S4 it may be determined whether an override condition exists. If so, then as in step S2, the functionality of the mobile communications device may not be limited.

However, if no override condition exists, then in step S5, the functionality of the mobile communications device may be limited. In one embodiment, this comprises limiting the operation of the mobile communications device to voice communications only via the vehicle's entertainment system. In other words, the mobile communications device will allow the placement and receipt of voice calls, such as via the vehicle's communication or entertainment system (such as using user inputs at the steering wheel, touch screen, keypad, etc. of that system). However, other forms of communication, including text, instant messaging, email, web browsing or other communications, are blocked or prevented. This would prevent, for example, the driver from using their mobile communications device to receive or read an incoming text or email or to send an outgoing text or email.

As indicated above, the functionality blocking may be implemented in various manners. In one embodiment, use of the mobile communication device's inputs, such as a keyboard or keypad, may be blocked or locked or a communication link which permits web browsing may be blocked. In other embodiments, the send/receive function of text messaging or email messaging may be temporality disabled. For example, in one embodiment the mobile communications device may have the keyboard and/or keypad locked, thus preventing the user from making calls via other than the vehicle entertainment system and preventing the user from accessing the text, email, web browser and other functions (including other applications) of the mobile communications device.

Once the communication link with the vehicle's entertainment system is terminated or a qualifying condition no longer exists (such as because the driver gets out of the driver's seat or puts the car in Park or an override condition exists), the full functionality of the mobile communications device may be restored.

In one embodiment, while the functionality described herein may be implemented by a software application installed on the mobile communications device, the functionality may be implemented by a software application associated with the vehicle (such as the control system controller) and/or by a combination of thereof (wherein the software may be stored in a memory which is associated with the controller and which is configured to cause the controller to implement the functionality herein). For example, in one embodiment, when a communications link between a mobile communications device and a vehicle is detected by the vehicle, a controller of the vehicle may transmit vehicle information to the mobile communications device (such as regarding a condition of the driver's seat and/or transmission/shifter) and/or send instructions (such as a triggering signal in response to a detected vehicle operating condition) to the mobile communications device to limit the functionality thereof. In one embodiment, software may be associated with both a controller of the vehicle's control system and the mobile communications device, such as where the vehicle controller is configured to monitor for a communications link between the vehicle and the mobile communications device and detect or determine triggering vehicle conditions and, in such event, send a signal which, when received by the mobile device and processed by a processor thereof running software, limits communication functionality of the mobile device.

In one embodiment, such a software application may be downloaded and installed at the mobile communications device and/or vehicle, such as by the user thereof (or be installed or mandated by an employer, parent, insurance company, car rental agency or the like). In other embodiments, the software application or hardware for implementing the functionality described herein might be installed at the time the mobile communications device and/or vehicle is manufactured, such as by the manufacturer. Such “original” installation may not permit a user to delete or disable the functionality.

As indicated, in one embodiment, functionality blocking may be subject to an “override” condition. For example, in one embodiment a user may be permitted to utilize their mobile communications device to place emergency calls (such as by being permitted to dial 9-1-1 or other emergency numbers on the device's keypad and to effect such calls directly via the device). In other embodiments, a user may enter an override code which prevents the functionality blocking from being enabled.

In one embodiment, an administrator level type override may be enabled. For example, a parent (or employer, insurance company, car rental company, etc.) may install or enable the functionality described herein during the time their child (employee, insured, user, etc.) is using a vehicle, but may be permitted to disable the functionality (such as by input of a security code, password or the like) when they utilize the vehicle.

In one embodiment, the invention may include reporting functionality. For example, in the case where functionality is implemented by software, the software may include a reporting function which reports (such as to a parent, employer, insurance company, car rental agency, etc., such as by text, email or other communication) when a user has attempted to remove the application, disable the application, etc. Such reporting might include the ability to print or review a history of activity, including tampering events and/or other events, such as the times when the mobile communications device is linked to a vehicle, the particular vehicle to which it was linked, the use of the mobile communications device during times when the functionality is enabled, etc.

In one embodiment, a user may be prevented from turning off wireless connectivity in order to bypass the functionality described herein. For example, when the functionality described herein is enabled by a software application installed on the mobile communications device, such software may also prevent the user of the device from disabling the Bluetooth functionality as a means to avoid having the functionality described herein enabled.

In one embodiment, a mobile communications device and a vehicle may be matched or paired. For example, the software associated with a mobile communications device may be matched to a vehicle, such as by unique identification information (such as which can be obtained or exchanged between the vehicle and the mobile communications device for verification purposes).

The invention has numerous benefits and advantages. First, a mechanism is provided for limiting the functionality of a driver's mobile communications device without limiting the use or functionality of a passenger's mobile communications device. Second, the functionality of the driver's mobile communications device is not limited when the driver is not engaged in driving the vehicle, such as when the vehicle is parked or when the driver is not in the driver's seat. Thus, the driver may still utilize all of the features of their mobile communications device, including those enabled by the vehicle's entertainment system, when the driver is simply sitting in the vehicle or the like.

It will be understood that the above described arrangements of apparatus and the method there from are merely illustrative of applications of the principles of this invention and many other embodiments and modifications may be made without departing from the spirit and scope of the invention as defined in the claims.

1. A vehicle control system configured to limit the functionality of a mobile communications device utilized by a user of the vehicle comprising:
at least one controller;
at least one wireless communications interface configured to permit wireless communications with said mobile communications device; and
at least one vehicle operating condition sensor configured to provide an output to said at least one controller regarding a vehicle operating condition;
said at least one controller configured to, in response to a wireless communication link between said at least one wireless communications interface and said mobile communications device and the existence of at least one triggering vehicle operating condition, transmit a signal to said mobile communications device via said wireless communications link to cause said mobile communications device to disable non-voice communications functionality of said mobile device without disabling voice communications functionality of said mobile device.

2. The system in accordance with claim 1 further comprising:
at least one memory associated with said at least one controller; and
machine readable code stored in said memory and executable by said at least one controller, said machine readable code configured to cause said processor to:
determine the existence of said wireless communications link based upon information from said at least one wireless communications interface;
determine a triggering vehicle operating condition based upon the output of said least one vehicle operating condition sensor; and
generate said signal.

3. They system in accordance with claim 1 wherein said at least one triggering vehicle operating condition comprises at least one of said vehicle being in a driving gear and detection of a driver in a driver's seat of said vehicle.

4. The system in accordance with claim 1 wherein said at least one vehicle operating condition sensor comprises at least one of a driver's seat occupancy sensor, a transmission gear shift selector sensor and a driver's seat restraint sensor.

5. They system in accordance with claim 1 wherein said at least one signal causes said mobile communications device to prevent use of text, email and/or browser functionality thereof.

6. The system in accordance with claim 1 wherein said at least one controller is associated with a CAN BUS of said vehicle.

7. A non-transitory computer program product configured to limit communications functionality of a mobile communications device having a processor, at least one communications interface and a memory, comprising:
machine readable code stored in said memory of said mobile communications device configured to cause said processor of said mobile communications device to:
determine the existence of a communication link between said mobile communications device and a vehicle;
determine the existence of a triggering vehicle operating condition based upon vehicle operating condition information obtained from said vehicle; and
in response to said communication link and said triggering vehicle operating condition, disable non-voice communications functionality of said mobile device without disabling voice communications functionality of said mobile device.

8. The computer program product in accordance with claim 7 wherein said disabled non-voice communications functionality comprises text, browser and email communications functionality of said mobile communications device.

9. The computer program product in accordance with claim 8 wherein said non-voice communications functionality is disabled by preventing browser, text and/or email application operation.

10. The computer program product in accordance with claim 7 wherein said triggering vehicle operating condition comprises at least one of said vehicle being in a driving gear and detection of a driver in a driver's seat of said vehicle.

11. The computer program product in accordance with claim 7 wherein said processor is configured to send a polling signal to said vehicle requesting vehicle operating condition information.

12. The computer program product in accordance with claim 7 wherein said communication link comprises a wireless communication link with an entertainment system of said vehicle.

13. A method of limiting the functionality of a mobile communications device associated with a vehicle comprising the steps of:
detecting a communication coupling between said mobile communications device and a communication system of said vehicle;
detecting at least one vehicle operating condition; and
when at least one triggering vehicle operating condition exists, disabling non-voice communications functionality of said mobile device without disabling voice communications functionality of said mobile device.

14. The method in accordance with claim 13 wherein said triggering vehicle operating condition comprises at least one of said vehicle in a driving gear and a driver sitting in a driver's seat.

15. The method in accordance with claim 13 wherein said non-voice communications are disabled by preventing text and/or email communications.

16. The method in accordance with claim 13 wherein said non-voice communications are disabled by preventing use of a browser of said mobile communications device.

17. The method in accordance with claim 13 wherein said detecting comprises detecting a wireless communication link between said mobile communications device and an entertainment system of said vehicle.

18. The system in accordance with claim 1 wherein based upon said signal is transmitted to said mobile communications device via said wireless communications link, said user may still receive and make voice calls via said mobile communications device but said user is prevented from using a web-browser, from sending or receiving text messages, or from sending or receiving email messages via said mobile communications device.
